(19) United States
(12) Patent Application Publication
(10) Pub. No.: US 2013/0213506 A1
(43) Pub. Date: Aug. 22, 2013

(54) FLUID TRANSPORTATION DEVICE

(71) Applicant: Microjet Technology Co., Ltd., (US)

(72) Inventors: Shin-Chang Chen, Hsinchu (TW); Tsung-Pat Chou, Hsinchu (TW); Yau-Ji Li, Hsinchu (TW); Jia-Yu Liao, Hsinchu (TW)

(73) Assignee: MICROJET TECHNOLOGY CO., LTD, Hsinchu (TW)

(21) Appl. No.: 13/750,128

(22) Filed: Jan. 25, 2013

(30) Foreign Application Priority Data
Feb. 20, 2012 (TW) 101105461
Feb. 20, 2012 (TW) 101105484
Jan. 4, 2013 (TW) 102100357
Jan. 4, 2013 (TW) 102100358

(51) Int. Cl. F16K 11/24; F16K 31/02

(52) U.S. Cl. CPC F16K 11/24; F16K 31/02
USPC 137/597; 251/129.06

(57) ABSTRACT

A fluid transportation device includes a valve supporting module, a first fluid transportation module and a second fluid transportation module. Through the valve supporting module, the first fluid transportation module and the second fluid transportation module may be combined together in a side-by-side arrangement or a vertically-stacked arrangement. The combination of the first fluid transportation module and the second fluid transportation module can increase the flow rate and the pumping head of transporting the fluid. Moreover, the combination of two fluid transportation modules of the present fluid transportation device can be synchronously or asynchronously actuated to increase the flow rate and the pumping head of transporting the fluid. Since the additional coupling mechanism is omitted, the fabricating cost of the present fluid transportation device is largely reduced, and the overall volume of the present fluid transportation device is reduced to comply with the miniaturization requirement.

### FIELD OF THE INVENTION

The present invention relates to a fluid transportation device, and more particularly to a fluid transportation device with reduced volume and reduced fabricating cost.

### BACKGROUND OF THE INVENTION

With the advancement of science and technology, fluid transportation devices used in many sectors such as pharmaceutical industries, energy industries, computer techniques or printing industries are developed toward elaboration and miniaturization. The fluid transportation devices are important components that are used in for example micro pumps, micro atomizers, printheads or industrial printers for transporting small amounts of gases or liquids. Therefore, it is important to provide an improved structure of the fluid transportation device.

FIG. 1 is a schematic exploded view illustrating a conventional fluid transportation device. As shown in FIG. 1, the conventional fluid transportation device 1 comprises a valve seat 11, a valve cap 12, a valve membrane 13, an actuating member 14, and a cover plate 15. The valve membrane 13 comprises an inlet valve structure 131 and an outlet valve structure 132. The valve seat 11 comprises an inlet channel 111 and an outlet channel 112. A pressure cavity 123 is formed between the valve cap 12 and the actuating member 14. The valve membrane 13 is arranged between the valve seat 11 and the valve cap 12.

When an external voltage is applied on a top electrode and a bottom electrode of the actuating member 14, an electric field is generated. Due to the electric field, the actuating member 14 is subjected to deformation. If the electric field causes upward deformation of the actuating member 14 in the direction indicated as the arrow X, the volume of the pressure cavity 123 is expanded to result in suction. Due to the suction, the inlet valve structure 131 of the valve membrane 13 is opened. Consequently, the fluid is sucked into the inlet valve structure 131 through the inlet channel 111 of the valve seat 11, and then the fluid is introduced into the pressure cavity 123 through the inlet valve structure 131 of the valve membrane 13 and an inlet valve channel 121 of the valve cap 12. On the other hand, if the direction of the electric field is changed to cause downward deformation of the actuating member 14 in the direction reverse to the arrow X, the volume of the pressure cavity 123 is shrunken to exert an impulse on the fluid within the pressure cavity 123. At the same time, a downward impulse is exerted on the inlet valve structure 131 and the outlet valve structure 132 of the valve membrane 13. Due to the downward impulse, the outlet valve structure 132 is opened. Consequently, the fluid within the pressure cavity 123 is exhausted out of the fluid transportation device 1 through an outlet valve channel 122 of the valve cap 12, the outlet valve structure 132 of the valve membrane 13 and the outlet channel 112 of the valve seat 11. According to the above-mentioned principles, the purpose of transporting the fluid is achieved.

However, since the conventional fluid transportation device 1 comprises a single actuator, a single pressure cavity, a single flow path, a single inlet channel, a single outlet channel and a single pair of valve structures, it is difficult to increase the transportation amount of the fluid. For increasing the flow rate, plural fluid transportation devices 1 are in fluid communication with each other through an additional piping system. The piping system is connected between the valve seats 11 of the plural fluid transportation devices 1, so that these valve seats 11 are in fluid communication with each other. Then, these fluid transportation devices 1 are vertically stacked on each other. As known, the way of connecting these fluid transportation devices 1 needs additional cost of the piping system. Moreover, since the combination of these fluid transportation devices 1 has bulky, the overall volume of the end product is too large to comply with the miniaturization requirement.

Therefore, there is a need of providing an improved fluid transportation device in order to eliminate the above drawbacks.

### BRIEF SUMMARY OF THE INVENTION

The present invention provides a fluid transportation device. The fluid transportation device may be applied to a micro pump. The fluid transportation device comprises a valve supporting module, a first fluid transportation module and a second fluid transportation module. Through the valve supporting module, the first fluid transportation module and the second fluid transportation module may be combined together in a side-by-side arrangement or a vertically-stacked arrangement. In comparison with the conventional fluid transportation device with a single fluid transportation module, the combination of the first fluid transportation module and the second fluid transportation module can increase the flow rate and the pumping head of transporting the fluid. Moreover, in comparison with the conventional way of using a coupling mechanism (e.g. a piping system) to connect plural fluid transportation devices to increase the flow rate, the combination of two fluid transportation modules of the present fluid transportation device can be synchronously or asynchronously actuated to increase the flow rate and the pumping head of transporting the fluid. Since the additional coupling mechanism is omitted, the fabricating cost of the present fluid transportation device is largely reduced, and the overall volume of the present fluid transportation device is reduced to comply with the miniaturization requirement.

In accordance with an aspect of the present invention, there is provided a fluid transportation device for transporting a fluid. The fluid transportation device includes a valve supporting module, a first fluid transportation module, and a second fluid transportation module. The valve supporting module includes a first valve seat, a second valve seat, an inlet channel, an outlet channel and a communication chamber. The first valve seat and the second valve seat are located adjacent to each other and arranged at the same plane. The first valve seat includes a first outlet buffer cavity and a first opening. The first opening is in communication with the inlet channel. The second valve seat includes a second opening and a second outer buffer cavity. The second outer buffer cavity is in communication with the outlet channel. The first outlet buffer cavity and the second opening are in communication with each other through the communication chamber. The first fluid transportation module is disposed on the first valve seat, and includes a first actuating member, a first valve cap and a first valve membrane. The first valve membrane is arranged between the valve supporting module and the first valve cap, and has plural hollow-type valve switches respectively corresponding to the first opening and the first outlet buffer cavity. The first actuating member is disposed on the first valve cap. A first pressure cavity is defined between the first actuating member and a surface of the first valve cap. The second fluid transportation module is disposed on the second valve seat, and includes a second actuating member, a second valve cap and a second valve membrane. The second valve membrane is arranged between the valve supporting module and the second valve cap, and has plural hollow-type valve switches respectively corresponding to the second opening and the second outlet buffer cavity. The second actuating member is disposed on the second valve cap. A second pressure cavity is defined between the second actuating member and a surface of the second valve cap. When the first actuating member and the second actuating member are actuated at the same vibration frequency to cause a volume change of the first pressure cavity and a volume change of the second pressure cavity, a pressure difference is generated to push the fluid, so that the fluid is introduced into the inlet channel, transported between the first fluid transportation module, the first valve seat, the second valve seat and the second fluid transportation module, and exhausted out of the outlet channel.

In accordance with another aspect of the present invention, there is provided a fluid transportation device for transporting a fluid. The fluid transportation device includes a valve supporting module, a first fluid transportation module, and a second fluid transportation module. The valve supporting module includes a first surface, an inlet channel, an outlet channel, a second surface and a communication chamber. A first outlet buffer cavity and a first opening are formed in the first surface. The first opening is in communication with the inlet channel. A second opening and a second outer buffer cavity are formed in the second surface. The second outer buffer cavity is in communication with the outlet channel. The first outlet buffer cavity and the second opening are in communication with each other through the communication chamber. The first fluid transportation module is disposed on the first surface, and includes a first actuating member, a first valve cap and a first valve membrane. The first valve membrane is arranged between the valve supporting module and the first valve cap, and has plural hollow-type valve switches respectively corresponding to the first opening and the first outlet buffer cavity. The first actuating member is disposed on the first valve cap. A first pressure cavity is defined between the first actuating member and a surface of the first valve cap. The second fluid transportation module is disposed on the second surface, and located over or under the first fluid transportation module. The second fluid transportation module includes a second actuating member, a second valve cap and a second valve membrane. The second valve membrane is arranged between the valve supporting module and the second valve cap, and has plural hollow-type valve switches respectively corresponding to the second opening and the second outlet buffer cavity. The second actuating member is disposed on the second valve cap. A second pressure cavity is defined between the second actuating member and a surface of the second valve cap. When the first actuating member and the second actuating member are actuated at the same vibration frequency to cause a volume change of the first pressure cavity and a volume change of the second pressure cavity, a pressure difference is generated to push the fluid, so that the fluid is introduced into the inlet channel, transported between the first fluid transportation module, the first valve seat, the second valve seat and the second fluid transportation module, and exhausted out of the outlet channel.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view illustrating a conventional fluid transportation device;

FIG. 2A is a schematic perspective view illustrating the outer appearance of a fluid transportation device according to an embodiment of the present invention;

FIG. 2B is a schematic exploded view illustrating the fluid transportation device of FIG. 2A and taken along a front side;

FIG. 2C is a schematic exploded view illustrating the fluid transportation device of FIG. 2A and taken along a rear side;

FIG. 3 is a schematic enlarged view illustrating the valve membrane of the fluid transportation device of FIG. 2B;

FIG. 4 is a schematic cross-sectional view illustrating the fluid transportation device of FIG. 2A and taken along the line A-A;

FIG. 5A schematically illustrates the in-phase actuations of the first fluid transportation module and the second fluid transportation module of the fluid transportation device of FIG. 4 in a first situation;

FIG. 5B schematically illustrates the in-phase actuations of the first fluid transportation module and the second fluid transportation module of the fluid transportation device of FIG. 4 in a second situation;

FIG. 6A schematically illustrates the out-phase actuations of the first fluid transportation module and the second fluid transportation module of the fluid transportation device of FIG. 4 in a first situation;

FIG. 6B schematically illustrates the out-phase actuations of the first fluid transportation module and the second fluid transportation module of the fluid transportation device of FIG. 4 in a second situation;

FIG. 7A schematically illustrates the volume changes of the first pressure cavity and the second pressure cavity in response to the in-phase actuations of the first fluid transportation module and the second fluid transportation module of the fluid transportation device of FIG. 4;

FIG. 7B schematically illustrates the volume changes of the first pressure cavity and the second pressure cavity of the fluid transportation device of FIG. 4, in wherein there is a phase difference between the volume changes of the first pressure cavity and the second pressure cavity;

FIG. 8 schematically illustrates the volume changes of the first pressure cavity and the second pressure cavity in response to the out-phase actuations of the first fluid transportation module and the second fluid transportation module of the fluid transportation device of FIG. 4;

FIG. 9A is a schematic exploded view illustrating a fluid transportation device according to another embodiment of the present invention and taken along a front side;

FIG. 9B is a schematic exploded view illustrating the fluid transportation device of FIG. 9A and taken along a rear side;

FIG. 9C is a schematic top view illustrating the fluid transportation device of FIG. 9A;

FIG. 9D is a schematic cross-sectional view illustrating the fluid transportation device of FIG. 9C and taken along the line B-B;

FIG. 9E is a schematic enlarged view illustrating the valve membrane of the fluid transportation device of FIG. 9A;

FIG. 10A schematically illustrates the in-phase actuations of the first fluid transportation module and the second fluid transportation module of the fluid transportation device of FIG. 9D in a first situation;

FIG. 10B schematically illustrates the in-phase actuations of the first fluid transportation module and the second fluid transportation module of the fluid transportation device of FIG. 9D in a second situation;

FIG. 11A schematically illustrates the out-phase actuations of the first fluid transportation module and the second fluid transportation module of the fluid transportation device of FIG. 9D in a first situation; and

FIG. 11B schematically illustrates the out-phase actuations of the first fluid transportation module and the second fluid transportation module of the fluid transportation device of FIG. 9D in a second situation.

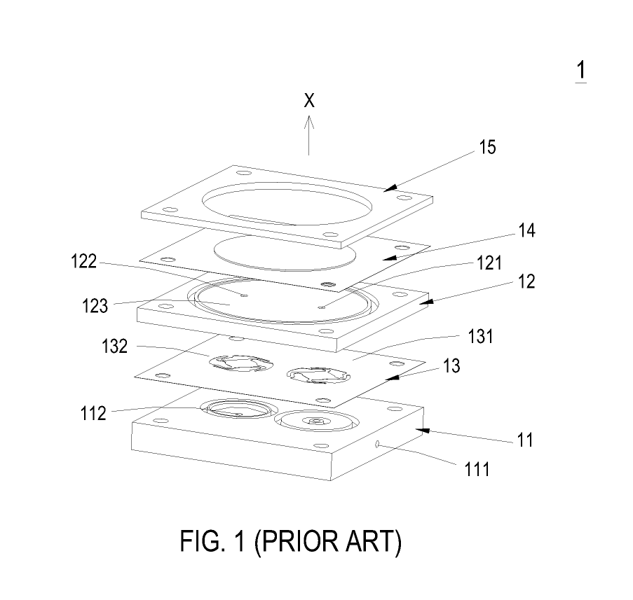

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present invention provides a fluid transportation device. The fluid transportation device may be used in many sectors such as pharmaceutical industries, energy industries computer techniques or printing industries for transporting fluids (e.g. gases or liquids).

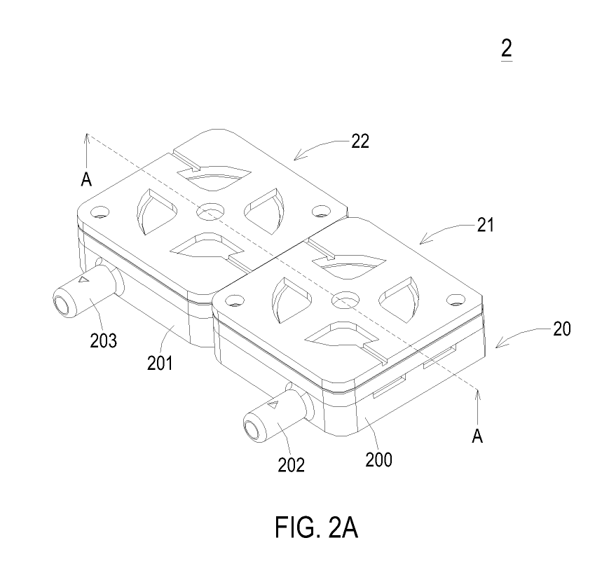

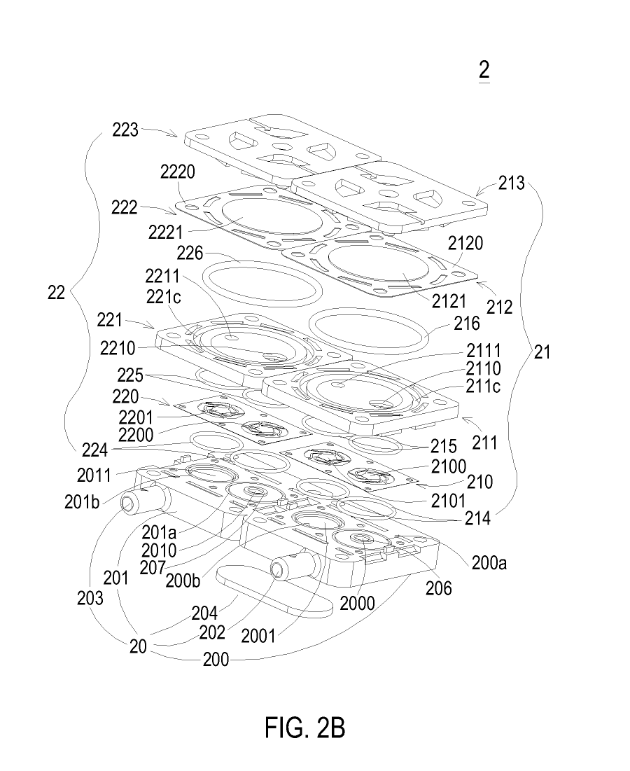

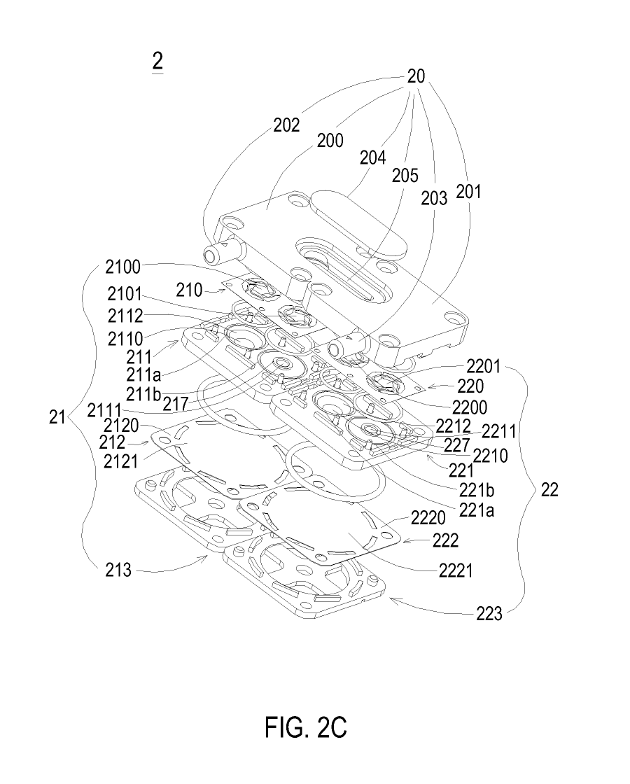

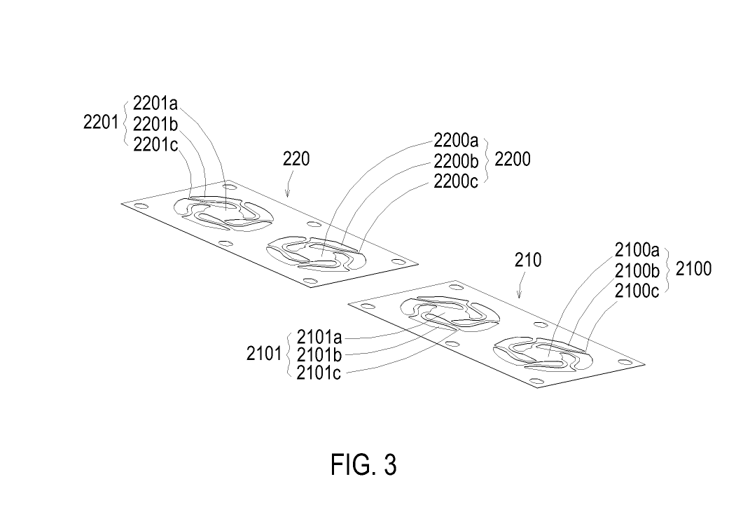

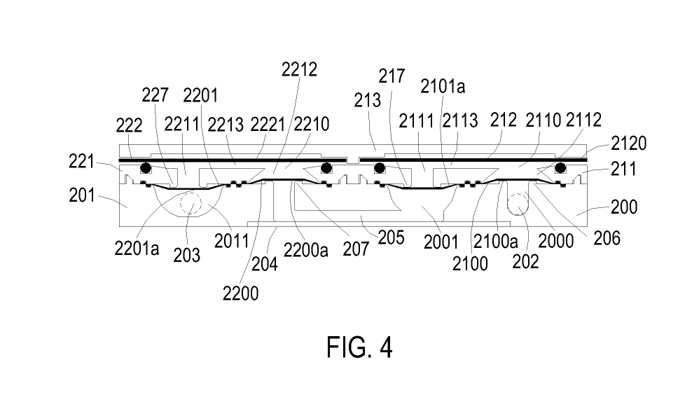

FIG. 2A is a schematic perspective view illustrating the outer appearance of a fluid transportation device according to an embodiment of the present invention. FIG. 2B is a schematic exploded view illustrating the fluid transportation device of FIG. 2A and taken along a front side. FIG. 2C is a schematic exploded view illustrating the fluid transportation device of FIG. 2A and taken along a rear side. FIG. 3 is a schematic enlarged view illustrating the valve membrane of the fluid transportation device of FIG. 2B. FIG. 4 is a schematic cross-sectional view illustrating the fluid transportation device of FIG. 2A and taken along the line A-A.

Please refer to FIGS. 2A, 2B, 2C, 3 and 4. The fluid transportation device 2 comprises a valve supporting module 20, a first fluid transportation module 21, and a second fluid transportation module 22.

The valve supporting module 20 comprises a first valve seat 200, a second valve seat 201, an inlet channel 202, an outlet channel 203, and a communication chamber 205. The first valve seat 200 and the second valve seat 201 are located adjacent to each other and located at the same plane. In some embodiments, the first valve seat 200 and the second valve seat 201 are integrally formed with each other. Alternatively, the first valve seat 200 and the second valve seat 201 are not integrally formed with each other. The first valve seat 200 comprises an opening 2000 and an outlet buffer cavity 2001. The opening 2000 is in communication with the inlet channel 202. The outlet buffer cavity 2001 is in communication with the first fluid transportation module 21. After a fluid is introduced into the inlet channel 202, the fluid is transported to the opening 2000. The outlet buffer cavity 2001 is used for temporarily storing the fluid therein. The second valve seat 201 also comprises an opening 2010 and an outlet buffer cavity 2011. The outlet buffer cavity 2011 is in communication with the second fluid transportation module 22. The outlet buffer cavity 2011 is in communication with the outlet channel 203, and the outlet buffer cavity 2011 is used for temporarily storing the fluid therein. The fluid contained in the outlet buffer cavity 2011 may be further exhausted out of the outlet channel 203. Moreover, the outlet buffer cavity 2001 of the first valve seat 200 and the opening 2010 of the second valve seat 201 are connected with and in communication with the communication chamber 205 (see FIG. 4).

The first fluid transportation module 21 is disposed on the first valve seat 200. Moreover, the first fluid transportation module 21 comprises a valve membrane 210, a valve cap 211, an actuating member 212 and a cover plate 213, which are stacked on each other. The valve membrane 210 is arranged between the first valve seat 200 and the valve cap 211, and aligned with the first valve seat 200 and the valve cap 211. The actuating member 212 is disposed over the valve cap 211. The actuating member 212 comprises a vibration film 2120 and an actuator 2121. When a voltage is applied on the actuating member 212, the actuating member 212 is subject to vibration. The cover plate 213 is disposed over the actuating member 212 for sealing the first fluid transportation module 21. After the valve membrane 210, the valve cap 211, the actuating member 212 and the cover plate 213 are sequentially stacked on the first valve seat 200 and combined together by fastening elements (not shown), the first fluid transportation module 21 is assembled.

The second fluid transportation module 22 is disposed on the second valve seat 201. The second fluid transportation module 22 and the first fluid transportation module 21 are located at the same side of the valve supporting module 20. Similarly, the second fluid transportation module 22 comprises a valve membrane 220, a valve cap 221, an actuating member 222 and a cover plate 223, which are stacked on each other. The actuating member 222 comprises a vibration film 2220 and an actuator 2221. The features and the assembling ways of the valve membrane 220, the valve cap 221, the actuating member 222 and the cover plate 223 of the second fluid transportation module 22 are similar to those of the valve membrane 210, the valve cap 211, the actuating member 212 and the cover plate 213 of the first fluid transportation module 21, and are not redundantly described herein.

In this embodiment, the valve cap 211 of the first fluid transportation module 21 and the valve cap 221 of the second fluid transportation module 22 are separate structures. Alternatively, the valve caps 211 and 221 may be integrally formed as a one-piece structure. Moreover, the relationship between the two valve caps 211 and 221 may be adjusted according to the requirements of the manufacturer or the user.

Each of the valve membranes 210 and 220 is a sheet-like membrane with substantially uniform thickness. Moreover, the valve membrane 210 comprises hollow-type valve switches 2100 and 2101, and the valve membrane 220 comprises hollow-type valve switches 2200 and 2201. The hollow-type valve switch 2100 comprises a valve slice 2100a, plural perforations 2100b around the valve slice 2100a, and plural extension parts 2100c between the valve slice 2100a and the perforations 2100b. Similarly, the hollow-type valve switch 2101 comprises a valve slice 2101a, plural perforations 2101b around the valve slice 2101a, and plural extension parts 2101c between the valve slice 2101a and the perforations 2101b. Similarly, the hollow-type valve switch 2200 comprises a valve slice 2200a, plural perforations 2200b around the valve slice 2200a, and plural extension parts 2200c between the valve slice 2200a and the perforations 2200b. Similarly, the hollow-type valve switch 2201 comprises a valve slice 2201a, plural perforations 2201b around the valve slice 2201a, and plural extension parts 2201c between the valve slice 2201a and the perforations 2201b.

The valve cap 211 of the first fluid transportation module 21 comprises an inlet valve channel 2110 and an outlet valve channel 2111, which are respectively aligned with the hollow-type valve switches 2100 and 2101 of the valve membrane 210. Moreover, an inlet buffer cavity 2112 is arranged between the hollow-type valve switch 2100 and the valve cap 211, and in communication with the inlet valve channel 2110. A first pressure cavity 2113 is defined between a surface of the valve cap 211 and the actuating member 212 (see FIG. 4). A port of the first pressure cavity 2113 is in communication with the inlet buffer cavity 2112 through the inlet valve channel 2110. Another port of the first pressure cavity 2113 is in communication with the outlet valve channel 2111. The valve cap 221 of the second fluid transportation module 22 comprises an inlet valve channel 2210 and an outlet valve channel 2211, which are respectively aligned with the hollow-type valve switches 2200 and 2201 of the valve membrane 220. Moreover, an inlet buffer cavity 2212 is arranged between the hollow-type valve switch 2200 and the valve cap 221, and in communication with the inlet valve channel 2210. A second pressure cavity 2213 is defined between a surface of the valve cap 221 and the actuating member 222 (see FIG. 4). A port of the second pressure cavity 2213 is in communication with the inlet buffer cavity 2212 through the inlet valve channel 2210. Another port of the second pressure cavity 2213 is in communication with the outlet valve channel 2211.

In some other embodiments, the first fluid transportation module 21 further comprises plural first sealing rings 214, plural second sealing rings 215 and a third sealing ring 216; and the second fluid transportation module 22 further comprises plural first sealing rings 224, plural second sealing rings 225 and a third sealing ring 226. Moreover, the first valve seat 200 has plural recesses. For example, the recess 200a annularly surrounds the opening 2000, and the recess 200b annularly surrounds the outlet buffer cavity 2001. Similarly, the second valve seat 201 has plural recesses. For example, the recess 201a annularly surrounds the opening 2010, and the recess 201b annularly surrounds the outlet buffer cavity 2011. The recesses 200a and 200b are used for accommodating corresponding first sealing rings 214, and the recesses 201a and 201b are used for accommodating corresponding first sealing rings 224. After the first sealing rings 214 are accommodated within the recesses 200a and 200b, the first valve seat 200 and the valve membrane 210 are in close contact with each other to prevent fluid leakage. Similarly, after the first sealing rings 224 are accommodated within the recesses 201a and 201b, the second valve seat 201 and the valve membrane 220 are in close contact with each other to prevent fluid leakage. Moreover, the valve caps 211 and 221 further comprise plural recesses. For example, the recess 211a annularly surrounds the inlet buffer cavity 2112 of the valve cap 211, the recess 211b annularly surrounds the outlet valve channel 2111 of the valve cap 211, the recess 221a annularly surrounds the inlet buffer cavity 2212 of the valve cap 221, and the recess 221b annularly surrounds the outlet valve channel 2211 of the valve cap 221. The recesses 211a and 211b are used for accommodating corresponding second sealing rings 215, and the recesses 221a and 221b are used for accommodating corresponding second sealing rings 225. After the second sealing rings 215 are accommodated within the recesses 211a and 211b, the valve cap 211 and the valve membrane 210 are in close contact with each other to prevent fluid leakage. After the second sealing rings 225 are accommodated within the recesses 221a and 221b, the valve cap 221 and the valve membrane 220 are in close contact with each other to prevent fluid leakage. Another surface of the valve cap 211 has a recess 211c, and another surface of the valve cap 221 has a recess 221c. The recess 211c annularly surrounds the first pressure cavity 2113. The recess 221c annularly surrounds the second pressure cavity 2213. The recess 211c is used for accommodating the third sealing ring 216, and the recess 221c is used for accommodating the third sealing ring 226. After the third sealing ring 216 is accommodated within the recess 211c, the vibration film 2120 of the actuating member 212 and the valve cap 211 are in close contact with each other to prevent fluid leakage. After the third sealing ring 226 is accommodated within the recess 221c, the vibration film 2220 of the actuating member 222 and the valve cap 221 are in close contact with each other to prevent fluid leakage.

When a voltage is applied to the actuator 2121 of the actuating member 212 to result in deformation of the actuator 2121, the vibration film 2120 connected with the actuator 2121 causes a volume change of the first pressure cavity 2113. Similarly, when a voltage is applied to the actuator 2221 of the actuating member 222 to result in deformation of the actuator 2221, the vibration film 2220 connected with the actuator 2221 causes a volume change of the second pressure cavity 2213. Due to the volume change, a pressure difference is generated to push the fluid. Consequently, the fluid is introduced into the inlet channel 202, then flowed into the first pressure cavity 2113 and the second pressure cavity 2213 through the hollow-type valve switches 2100 and 2200 of the valve membranes 210 and 220, and finally exhausted out of the outlet channel 203 through the hollow-type valve switches 2101 and 2201. In such way, the purpose of transporting the fluid is achieved.

In some other embodiments, a raised structure 206 is formed at the periphery of the opening 2000 of the first valve seat 200. The raised structure 206 is sustained against the valve slice 2100a of the hollow-type valve switch 2100 of the valve membrane 210 of the first fluid transportation module 21 so as to provide a pre-force to the valve slice 2100a. Moreover, a raised structure 207 is formed at the periphery of the opening 2010 of the second valve seat 201. The raised structure 207 is sustained against the valve slice 2200a of the hollow-type valve switch 2200 of the valve membrane 220 of the second fluid transportation module 22 so as to provide a pre-force to the valve slice 2200a. Moreover, a raised structure 217 is formed at the periphery of the outlet valve channel 2111 of the valve cap 211 of the first fluid transportation module 21. The raised structure 217 is sustained against the valve slice 2101a of the hollow-type valve switch 2101 of the valve membrane 210 of the first fluid transportation module 21 so as to provide a pre-force to the valve slice 2101a. Moreover, a raised structure 227 is formed at the periphery of the outlet valve channel 2211 of the valve cap 221 of the second fluid transportation module 22. The raised structure 227 is sustained against the valve slice 2201a of the hollow-type valve switch 2201 of the valve membrane 220 of the second fluid transportation module 22 so as to provide a pre-force to the valve slice 2201a.

The valve supporting module 20 further comprises a chamber sheltering plate 204 corresponding to the communication position of the outlet buffer cavity 2001 of the first valve seat 200 and the opening 2010 of the second valve seat 201. The chamber sheltering plate 204 is detachably disposed on the valve supporting module 20. When the chamber sheltering plate 204 is disposed on the valve supporting module 20, the communication position of the outlet buffer cavity 2001 of the first valve seat 200 and the opening 2010 of the second valve seat 201 is sheltered by the chamber sheltering plate 204.

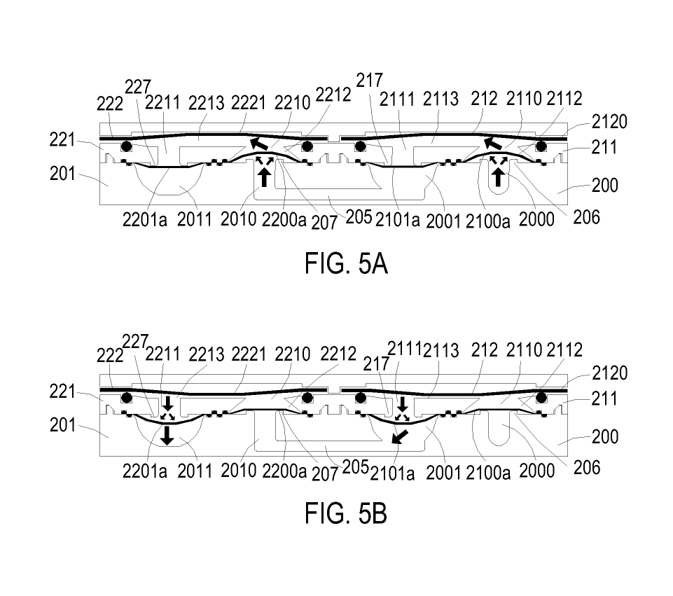

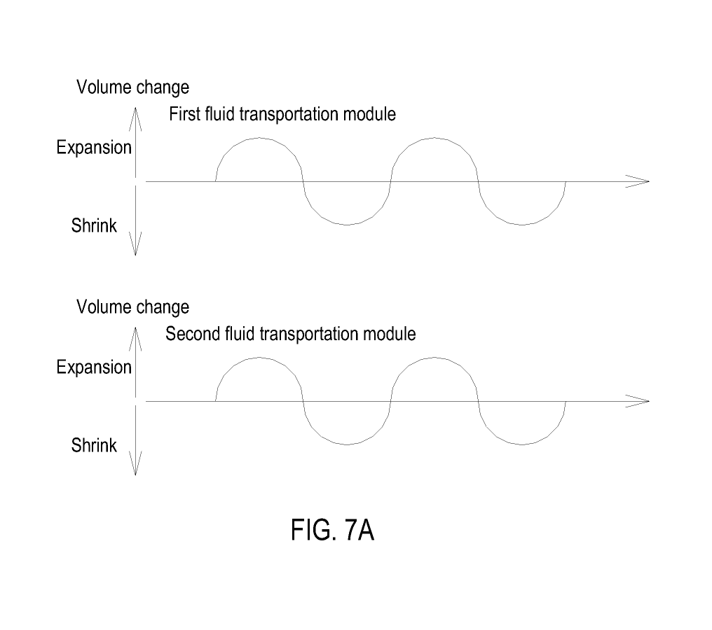

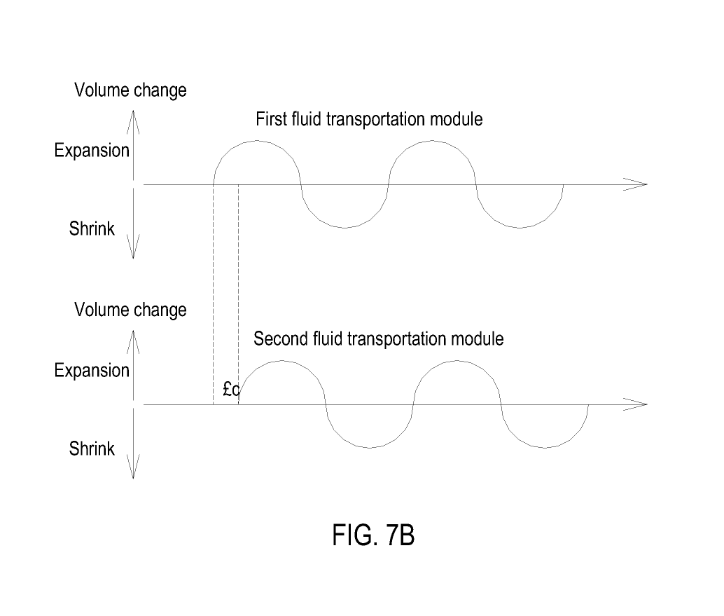

FIG. 5A schematically illustrates the in-phase actuations of the first fluid transportation module and the second fluid transportation module of the fluid transportation device of FIG. 4 in a first situation. FIG. 5B schematically illustrates the in-phase actuations of the first fluid transportation module and the second fluid transportation module of the fluid transportation device of FIG. 4 in a second situation. FIG. 7A schematically illustrates the volume changes of the first pressure cavity and the second pressure cavity in response to the in-phase actuations of the first fluid transportation module and the second fluid transportation module of the fluid transportation device of FIG. 4. Please refer to FIGS. 5A, 5B, 7A as well as FIGS. 2A, 2B, 2C and 4.

When a voltage is applied to the actuating member 212 of the first fluid transportation module 21 and the actuating member 222 of the second fluid transportation module 22 to cause in-phase actuations of the actuating member 212 and the actuating member 222 at the same vibration frequency, the first pressure cavity 2113 and the second pressure cavity 2213 are synchronously shrunken or synchronously expanded. Due to the in-phase actuations of the actuating member 212 and the actuating member 222, the actuating member 212 and the actuating member 222 are subjected to upward deformation. As shown in FIG. 5A, the volume of the first pressure cavity 2113 is expanded to result in suction, the volume of the second pressure cavity 2213 is expanded to result in suction, and the valve slices 2100a and 2200a with the pre-forces are quickly opened. Consequently, a great amount of fluid is sucked into the inlet channel 202. The fluid is transported through the perforations 2100b at a side of the hollow-type valve switch 2100 of the valve membrane 210, the inlet buffer cavity 2112 of the valve cap 211 and the inlet valve channel 2110 of the valve cap 211, and introduced into the first pressure cavity 2113. Similarly, the fluid is transported through the perforations 2200b at a side of the hollow-type valve switch 2200 of the valve membrane 220, the inlet buffer cavity 2212 of the valve cap 221 and the inlet valve channel 2210 of the valve cap 221, and introduced into the second pressure cavity 2213.

Please refer to FIGS. 5B and 7A. As the direction of the electric field is changed, the actuating member 212 of the first fluid transportation module 21 and the actuating member 222 of the second fluid transportation module 22 are subjected to downward deformation. Consequently, the volume of the first pressure cavity 2113 is shrunken to exert an impulse on the fluid within the first pressure cavity 2113, and the volume of the second pressure cavity 2213 is shrunken to exert an impulse on the fluid within the second pressure cavity 2213. Due to the impulse exerted on the hollow-type valve switch 2101 of the valve membrane 210 of the first fluid transportation module 21 and the impulse exerted on the hollow-type valve switch 2201 of the valve membrane 220 of the second fluid transportation module 22, the valve slice 2101a of the first fluid transportation module 21 and the valve slice 2201a of the second fluid transportation module 22 will be quickly opened and a great amount of fluid will be instantaneously ejected out. Moreover, since the fluid within the first pressure cavity 2113 is guided by the first pressure cavity 2113, the fluid will be transported through the outlet valve channel 2111 of the first fluid transportation module 21, the perforations 2101b of the valve membrane 210 and the outlet buffer cavity 2001 of the first valve seat 200, and flowed to the opening 2010 of the second valve seat 201. Moreover, since the fluid within the second pressure cavity 2213 is guided by the second pressure cavity 2213, the fluid will be transported through the outlet valve channel 2211 of the second fluid transportation module 22, the perforations 2201b of the valve membrane 220 and the outlet buffer cavity 2011 of the second valve seat 201, and flowed out of the outlet channel 203.

Similarly, since the impulse is also exerted on the hollow-type valve switch 2100 of the first fluid transportation module 21, the whole hollow-type valve switch 2100 is pressed down to lie flat on the first valve seat 200. Similarly, since the impulse is also exerted on the hollow-type valve switch 2200 of the second fluid transportation module 22, the whole hollow-type valve switch 2200 is pressed down to lie flat on the second valve seat 201. Meanwhile, the valve slice 2100a of the first fluid transportation module 21 and the valve slice 2200a of the second fluid transportation module 22 are respectively in close contact with the raised structure 206 of the first valve seat 200 and the raised structure 207 of the second valve seat 201. Consequently, the opening 2000 of the first valve seat 200 is sealed by the raised structure 206, and the opening 2010 of the second valve seat 201 is sealed by the raised structure 207. At the same time, the perforations 2100b and the extension parts 2100c of the first fluid transportation module 21 are correspondingly floated over the first valve seat 200, and the perforations 2200b and the extension parts 2200c of the second fluid transportation module 22 are correspondingly floated over the second valve seat 201. Under this circumstance, the hollow-type valve switch 2100 of the first fluid transportation module 21 and the hollow-type valve switch 2200 of the second fluid transportation module 22 are closed, and thus no fluid can be flowed out of the hollow-type valve switches 2100 and 2200.

From the above discussions, according to the actions of the actuating member 212 of the first fluid transportation module 21 and the actuating member 222 of the second fluid transportation module 22, the volume of the first pressure cavity 2113 and the volume of the second pressure cavity 2213 are shrunken or expanded to drive transportation of the fluid. Consequently, a great amount of fluid is introduced into the first pressure cavity 2113 and the second pressure cavity 2213 through the hollow-type valve switch 2100 of the first fluid transportation module 21 and the hollow-type valve switch 2200 of the second fluid transportation module 22, respectively. Since the fluid is guided by the first pressure cavity 2113 and the second pressure cavity 2213, the fluid within the first pressure cavity 2113 will be flowed out of the valve cap 211 of the first fluid transportation module 21 through the hollow-type valve switch 2101 of the first fluid transportation module 21, and the fluid within the second pressure cavity 2213 will be flowed out of the valve cap 221 of the second fluid transportation module 22 through the hollow-type valve switch 2201 of the second fluid transportation module 22. Moreover, since all buffer cavities of the fluid transportation device 2 are sealed by the plural first sealing rings 214, 224, the plural second sealing rings 215, 225 and the third sealing rings 216, 226, these sealing rings can effectively prevent fluid leakage.

During operation of the conventional fluid transportation device with a single actuating member, the flow rate is about 50 ml/min, and the pumping head is about 45 kPa. In the fluid transportation device 2 of the present invention, the first valve seat 200 and the second valve seat 201 of the valve supporting module 20 are located at the same plane, and the first valve seat 200 and the second valve seat 201 are in communication with each other through the communication chamber 205. In response to the in-phase actuations of the actuating member 212 of the first fluid transportation module 21 and the actuating member 222 of the second fluid transportation module 22, the use of the fluid transportation device 2 of the present invention can increase the flow rate to about 95 ml/min and increase the pumping head to about 90 kPa.

In some embodiments, the actuating member 212 of the first fluid transportation module 21 and the actuating member 222 of the second fluid transportation module 22 are vibrated at the same vibration frequency, but the first pressure cavity 2113 and the second pressure cavity 2213 are asynchronously shrunken or expanded. That is, there is a phase difference θ between the deformation amount of the actuating member 212 of the first fluid transportation module 21 and the deformation amount of the actuating member 222 of the second fluid transportation module 22. Consequently, there is the phase difference θ between the volume change of the first pressure cavity 2113 and the voltage change of the second pressure cavity 2213 (see FIG. 7B). By adjusting the magnitude of the phase difference θ, the flow rate and the pumping head of the fluid transportation device are correspondingly adjusted. Since the optimal flow rate and the optimal pumping head can be determined according to the practical requirements, the fluid transportation device of the present invention can be applied to various products more flexibly.

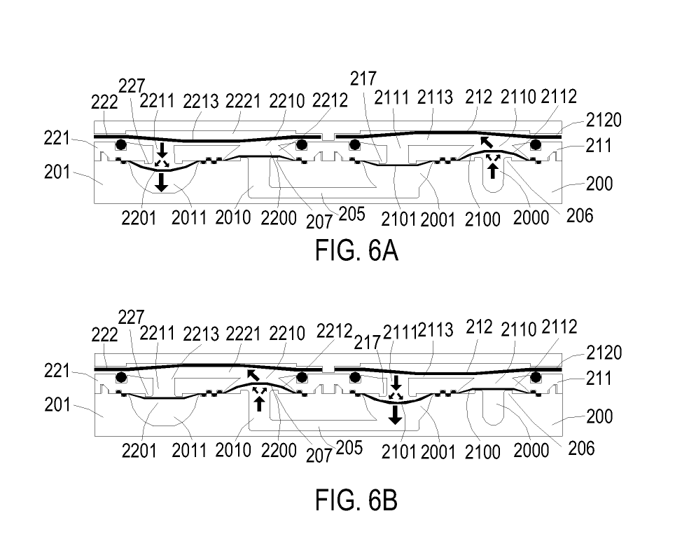

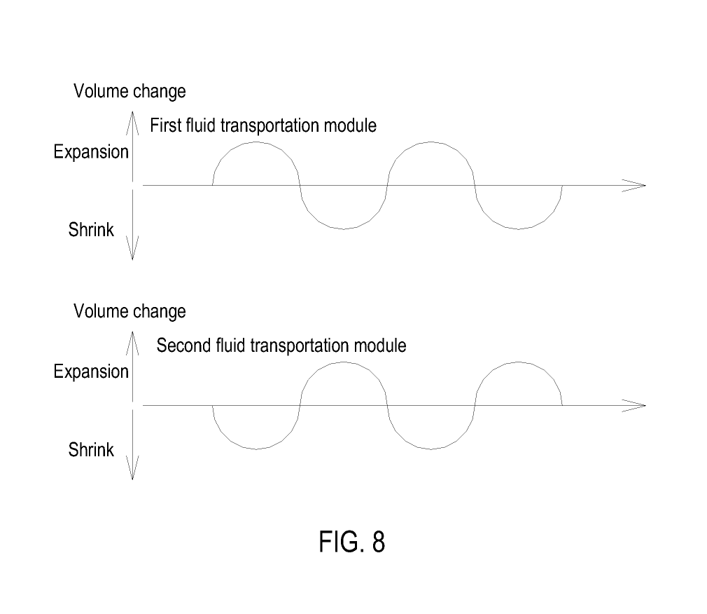

FIG. 6A schematically illustrates the out-phase actuations of the first fluid transportation module and the second fluid transportation module of the fluid transportation device of FIG. 4 in a first situation. FIG. 6B schematically illustrates the out-phase actuations of the first fluid transportation module and the second fluid transportation module of the fluid transportation device of FIG. 4 in a second situation. FIG. 8 schematically illustrates the volume changes of the first pressure cavity and the second pressure cavity in response to the out-phase actuations of the first fluid transportation module and the second fluid transportation module of the fluid transportation device of FIG. 4. Please refer to FIGS. 6A, 6B, 8 as well as FIGS. 2A, 2B, 2C and 4.

When a voltage is applied to the actuating member 212 of the first fluid transportation module 21 and the actuating member 222 of the second fluid transportation module 22 to cause out-phase actuations of the actuating member 212 and the actuating member 222 at the same vibration frequency, the actuating member 212 of the first fluid transportation module 21 is subjected to upward deformation, but the actuating member 222 of the second fluid transportation module 22 is subjected to downward deformation. Under this circumstance, the volume of the first pressure cavity 2113 is expanded, and the volume of the second pressure cavity 2213 is shrunken. Due to the out-phase actuations of the actuating member 212 and the actuating member 222, the fluid can be also introduced into the inlet channel 202 and flowed out of the outlet channel 203. During the out-phase actuations of the actuating member 212 of the first fluid transportation module 21 and the actuating member 222 of the second fluid transportation module 22, the use of the fluid transportation device 2 of the present invention can increase the flow rate to about 50 ml/min and increase the pumping head to the maximum value (e.g. 100 kPa).

In the above embodiment, the present invention provides a fluid transportation device. The fluid transportation device comprises a valve supporting module, a first fluid transportation module and a second fluid transportation module. The valve supporting module comprises a first valve seat and a second valve seat, which are parallel with each other and located at the same plane. An outlet buffer cavity of the first valve seat is in communication with an opening of the second valve seat. The first fluid transportation module is disposed on the first valve seat. The second fluid transportation module is disposed on the second valve seat. In comparison with the conventional fluid transportation device comprising a single actuating member, a single pressure cavity, a single flow path, a single inlet channel, a single outlet channel and a single pair of valve structures, the present fluid transportation device comprising the first fluid transportation module and the second fluid transportation module can increase the flow rate and the pumping head. Moreover, in comparison with the conventional way of using a coupling mechanism (e.g. a piping system) to connect plural fluid transportation devices to increase the flow rate, the volume of the present fluid transportation device is largely reduced and the purpose of miniaturization is achieved. Moreover, since the additional coupling mechanism is omitted, the fabricating cost of the present fluid transportation device is largely reduced. Moreover, by adjusting the in-phase actuations or the out-phase actuations of the first actuator and the second actuator or adjusting the phase difference between the deformation amount of the first actuator and the deformation amount of the second actuator, the flow rate and the pumping head of the fluid transportation device of the present invention is correspondingly controlled.

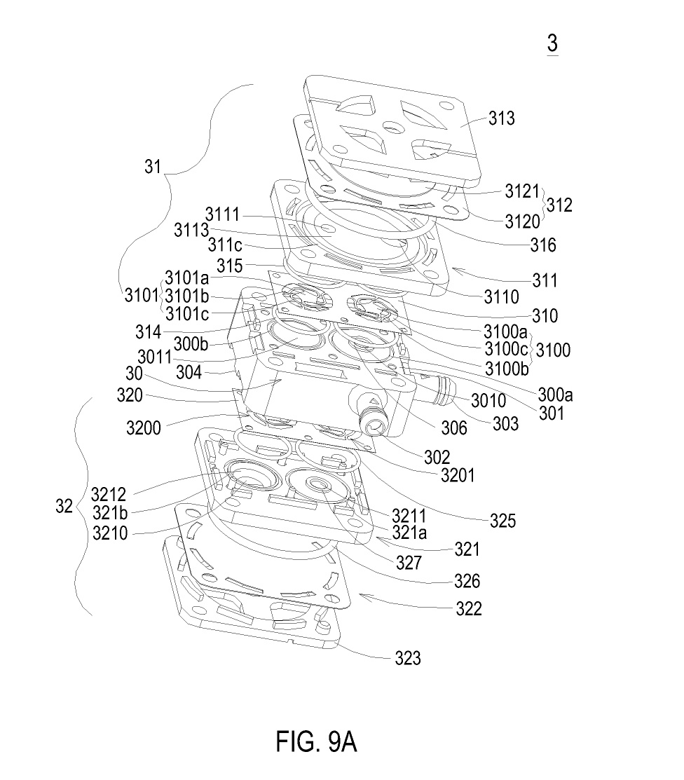

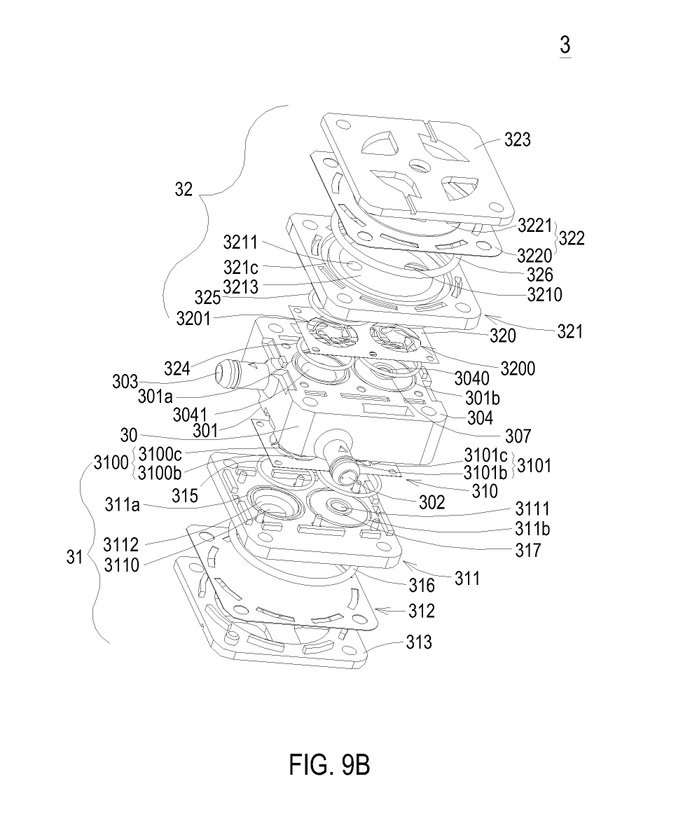

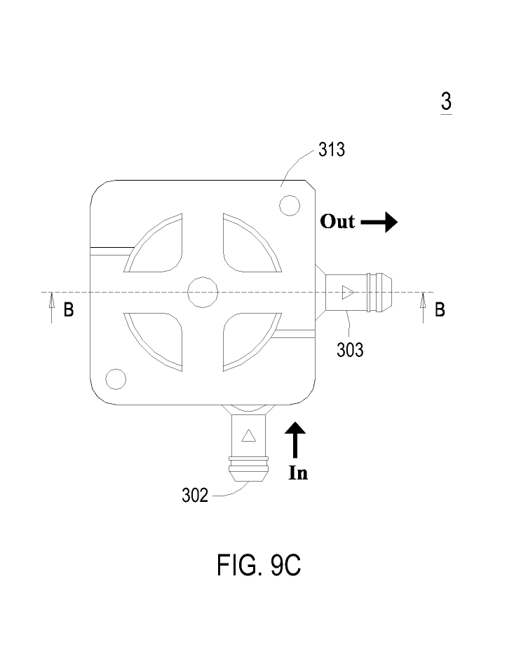

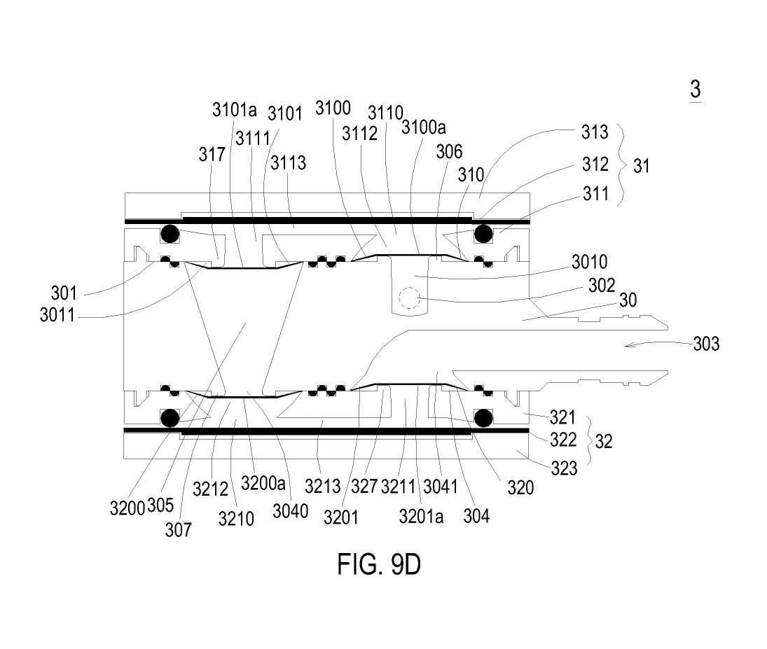

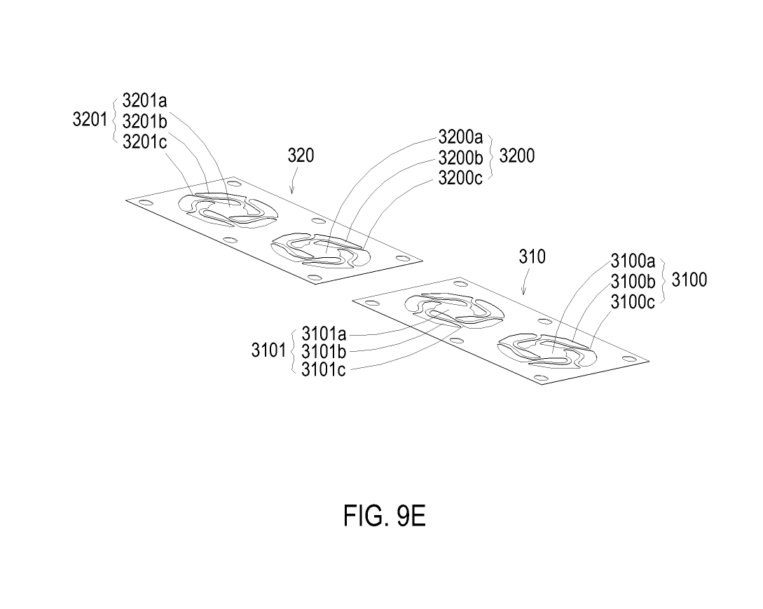

In the above embodiment, the first fluid transportation module and the second fluid transportation module of the fluid transportation device are arranged side-by-side. Moreover, in some other embodiments, the first fluid transportation module and the second fluid transportation module of the fluid transportation device may be vertically stacked on each other. FIG. 9A is a schematic exploded view illustrating a fluid transportation device according to another embodiment of the present invention and taken along a front side. FIG. 9B is a schematic exploded view illustrating the fluid transportation device of FIG. 9A and taken along a rear side. FIG. 9C is a schematic top view illustrating the fluid transportation device of FIG. 9A. FIG. 9D is a schematic cross-sectional view illustrating the fluid transportation device of FIG. 9C and taken along the line B-B. FIG. 9E is a schematic enlarged view illustrating the valve membrane of the fluid transportation device of FIG. 9A.

Please refer to FIGS. 9A-9E. The fluid transportation device 3 comprises a valve supporting module 30, a first fluid transportation module 31, and a second fluid transportation module 32. The first fluid transportation module 31 and the second fluid transportation module 32 are vertically stacked on each other.

The valve supporting module 30 is substantially a rectangular structure. Moreover, the valve supporting module 30 comprises a first surface 301, an inlet channel 302, an outlet channel 303, a second surface 304, and a communication chamber 305.

The first fluid transportation module 31 comprises a valve membrane 310, a valve cap 311, an actuating member 312 and a cover plate 313. The valve membrane 310 is arranged between the valve supporting module 30 and the valve cap 311, and aligned with the valve supporting module 30 and the valve cap 311. The actuating member 312 is disposed over the valve cap 311. The actuating member 312 comprises a vibration film 3120 and an actuator 3121. When a voltage is applied on the actuating member 312, the actuating member 312 is subject to vibration. The cover plate 313 is disposed on the actuating member 312 and opposed to the valve cap 311 with respect to the actuating member 312. The cover plate 313 is used for sealing the whole first fluid transportation module 31. After the valve membrane 310, the valve cap 311, the actuating member 312 and the cover plate 313 are sequentially stacked on the valve supporting module 30 and combined together by fastening elements (not shown), the first fluid transportation module 31 is assembled. Moreover, a first pressure cavity 3113 is defined between a surface of the valve cap 311 and the actuating member 312.

The second fluid transportation module 32 comprises a valve membrane 320, a valve cap 321, an actuating member 322 and a cover plate 323. The features and the assembling ways of the valve membrane 320, the valve cap 321, the actuating member 322 and the cover plate 323 of the second fluid transportation module 32 are similar to those of the valve membrane 310, the valve cap 311, the actuating member 312 and the cover plate 313 of the first fluid transportation module 31, and are not redundantly described herein. Moreover, the actuating member 322 comprises a vibration film 3220 and an actuator 3221. Similarly, a second pressure cavity 3213 is defined between a surface of the valve cap 321 and the actuating member 322.

The first fluid transportation module 31 and the second fluid transportation module 32 are located at a top side and a bottom side of the valve supporting module 30, respectively. That is, the first fluid transportation module 31 is disposed on the first surface 301 of the valve supporting module 30, and the second fluid transportation module 32 is disposed on the second surface 304 of the valve supporting module 30. An opening 3010 is formed in the first surface 301 of the valve supporting module 30 and in communication with the inlet channel 302. Moreover, an outlet buffer cavity 3011 is also formed in the first surface 301 of the valve supporting module 30 and in communication with the valve membrane 310 of the first fluid transportation module 31. An opening 3040 is formed in the second surface 304 of the valve supporting module 30. Moreover, an outlet buffer cavity 3041 is also formed in the second surface 304 of the valve supporting module 30 and in communication with the valve membrane 320 of the second fluid transportation module 32. The outlet buffer cavity 3041 is in communication with the outlet channel 303. Moreover, the outlet buffer cavity 3011 in the first surface 301 and the opening 3040 in the second surface 304 are connected with and in communication with the communication chamber 305. More especially, the communication chamber 305 is tapered from the outlet buffer cavity 3011 of the first surface 301 to the opening 3040 of the second surface 304. The communication chamber 305 is used for collecting the fluid and increasing the flow rate of the fluid. Due to the tapered structure of the communication chamber 305, the fluid is guided to be quickly transported through the valve membrane 310 of the first fluid transportation module 31 and flowed to the valve membrane 320 of the second fluid transportation module 32. Consequently, the speed of transporting the fluid from the first fluid transportation module 31 to the second fluid transportation module 32 is increased.

When a voltage is applied to the actuating member 312 of the first fluid transportation module 31 to result in deformation of the actuating member 312, a volume change of the first pressure cavity 3113 is generated. Similarly, when a voltage is applied to the actuating member 322 of the second fluid transportation module 32 to result in deformation of the actuating member 322, a volume change of the second pressure cavity 3213. Due to the volume change, a pressure difference is generated to push the fluid. Consequently, the fluid is introduced into the inlet channel 302, flowed between the first fluid transportation module 31, the valve supporting module 30 and the second fluid transportation module 32, and exhausted out of the outlet channel 303.

Each of the valve membrane 310 of the first fluid transportation module 31 and the valve membrane 320 of the second fluid transportation module 32 is a sheet-like membrane with substantially uniform thickness. Moreover, each of the valve membranes 310 and 320 comprises plural hollow-type valve switches. In this embodiment, the valve membrane 310 of the first fluid transportation module 31 comprises two hollow-type valve switches 3100 and 3101. The hollow-type valve switch 3100 comprises a valve slice 3100a, plural perforations 3100b around the valve slice 3100a, and plural extension parts 3100c between the valve slice 3100a and the perforations 3100b. Similarly, the hollow-type valve switch 3101 comprises a valve slice 3101a, plural perforations 3101b around the valve slice 3101a, and plural extension parts 3101c between the valve slice 3101a and the perforations 3101b. The structure of the valve membrane 320 of the second fluid transportation module 32 is similar to the structure of the valve membrane 310 of the first fluid transportation module 31, and is not redundantly described herein. In this embodiment, the valve membrane 320 of the second fluid transportation module 32 comprises two hollow-type valve switches 3200 and 3201. Similarly, the hollow-type valve switch 3200 comprises a valve slice 3200a, plural perforations 3200b, and plural extension parts 3200c. Similarly, the hollow-type valve switch 3201 comprises a valve slice 3201a, plural perforations 3201b, and plural extension parts 3201c.

The valve cap 311 of the first fluid transportation module 31 comprises an inlet valve channel 3110 and an outlet valve channel 3111, which are respectively aligned with the hollow-type valve switches 3100 and 3101 of the valve membrane 310. Moreover, an inlet buffer cavity 3112 is arranged between the hollow-type valve switch 3100 and the valve cap 311, and in communication with the inlet valve channel 3110. The inlet buffer cavity 3112 is used for temporarily storing the fluid therein. The first pressure cavity 3113 is defined between a surface of the valve cap 311 and the actuating member 312 (see FIG. 9D). A port of the first pressure cavity 3113 is in communication with the inlet buffer cavity 3112 through the inlet valve channel 3110. Another port of the first pressure cavity 3113 is in communication with the outlet valve channel 3111. Similarly, the valve cap 321 of the second fluid transportation module 32 comprises an inlet valve channel 3210 and an outlet valve channel 3211, which are respectively aligned with the hollow-type valve switches 3200 and 3201 of the valve membrane 320. Moreover, an inlet buffer cavity 3212 is arranged between the hollow-type valve switch 3200 and the valve cap 321, and in communication with the inlet valve channel 3210. The inlet buffer cavity 3212 is used for temporarily storing the fluid therein. The second pressure cavity 3213 is defined between a surface of the valve cap 321 and the actuating member 322 (see FIG. 9D). A port of the second pressure cavity 3213 is in communication with the inlet buffer cavity 3212 through the inlet valve channel 3210. Another port of the second pressure cavity 3213 is in communication with the outlet valve channel 3211.

In some other embodiments, as shown in FIGS. 9A and 9B, the first fluid transportation module 31 further comprises plural first sealing rings 314, plural second sealing rings 315 and a third sealing ring 316. Moreover, the first surface 301 of the valve supporting module 30 has plural recesses 300a and 300b. The recesses 300a and 300b are used for accommodating corresponding first sealing rings 314. After the first sealing rings 314 are accommodated within the recesses 300a and 300b, the first surface 301 of the valve supporting module 30 and the valve membrane 310 are in close contact with each other to prevent fluid leakage. Moreover, the surfaces of the valve cap 311 further comprise plural recesses 311a, 311b and 311c. The recesses 311a and 311b are formed in one surface of the valve cap 311. The recess 311a annularly surrounds the inlet valve channel 3110, and the recess 311b annularly surrounds the outlet valve channel 3111. The recesses 311a and 311b are used for accommodating corresponding second sealing rings 315. After the second sealing rings 315 are accommodated within the recesses 311a and 311b, the valve cap 311 and the valve membrane 310 are in close contact with each other to prevent fluid leakage. The recess 311c is formed in another surface of the valve cap 311. The recess 311c annularly surrounds the first pressure cavity 3113. The recess 311c is used for accommodating the third sealing ring 316. After the third sealing ring 316 is accommodated within the recess 311c, the actuating member 312 and the valve cap 311 are in close contact with each other to prevent fluid leakage. The locations of the first sealing rings 324, the second sealing rings 325, the third sealing ring 326 and the corresponding recesses 321a, 321b and 321c of the second fluid transportation module 32 are similar to those of the first sealing rings 314, the second sealing rings 315, the third sealing ring 316 and the corresponding recesses 311a, 311b and 311c of the first fluid transportation module 31, and are not redundantly described herein.

In some other embodiments, as shown in FIGS. 9A, 9B and 9D, a raised structure 306 is formed at the periphery of the opening 3010 of the first surface 301 of the valve supporting module 30. The raised structure 306 is sustained against the valve slice 3100a of the hollow-type valve switch 3100 of the valve membrane 310 of the first fluid transportation module 31 so as to provide a pre-force to the valve slice 3100a. Moreover, a raised structure 307 is formed at the periphery of the opening 3040 of the second surface 304 of the valve supporting module 30. The raised structure 307 is sustained against the valve slice 3200a of the hollow-type valve switch 3200 of the valve membrane 320 of the second fluid transportation module 32 so as to provide a pre-force to the valve slice 3200a. Moreover, a raised structure 317 is formed at the periphery of the outlet valve channel 3111 of the valve cap 311 of the first fluid transportation module 31. The raised structure 317 is sustained against the valve slice 3101a of the hollow-type valve switch 3101 of the valve membrane 310 of the first fluid transportation module 31 so as to provide a pre-force to the valve slice 3101a. Moreover, a raised structure 327 is formed at the periphery of the outlet valve channel 3211 of the valve cap 321 of the second fluid transportation module 32. The raised structure 327 is sustained against the valve slice 3201a of the hollow-type valve switch 3201 of the valve membrane 320 of the second fluid transportation module 32 so as to provide a pre-force to the valve slice 3201a.

In this embodiment, the inlet channel 302 and the outlet channel 303 are located at two adjacent surfaces of the valve supporting module 30, respectively. Alternatively, in some other embodiments, the inlet channel 302 and the outlet channel 303 are located at two opposite surfaces of the valve supporting module 30, respectively. It is noted that the positions of the inlet channel 302 and the outlet channel 303 may be varied according to the practical requirements.

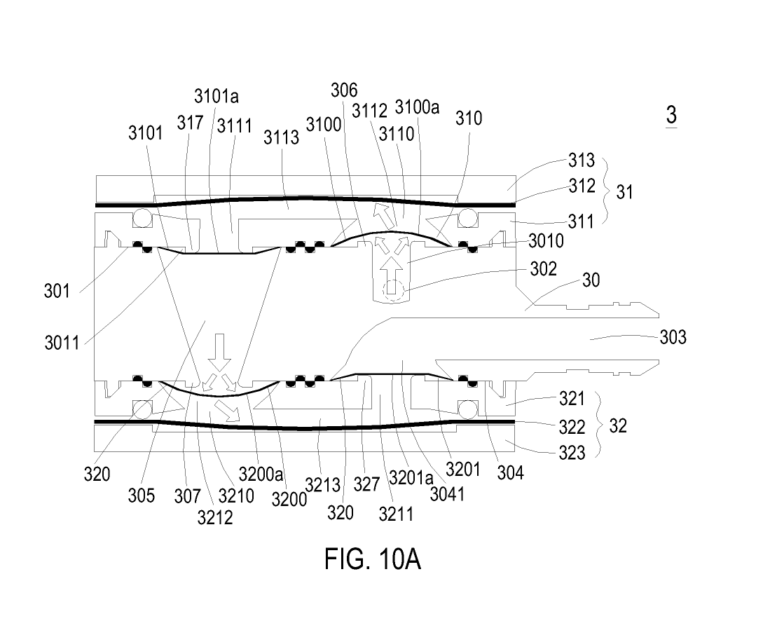

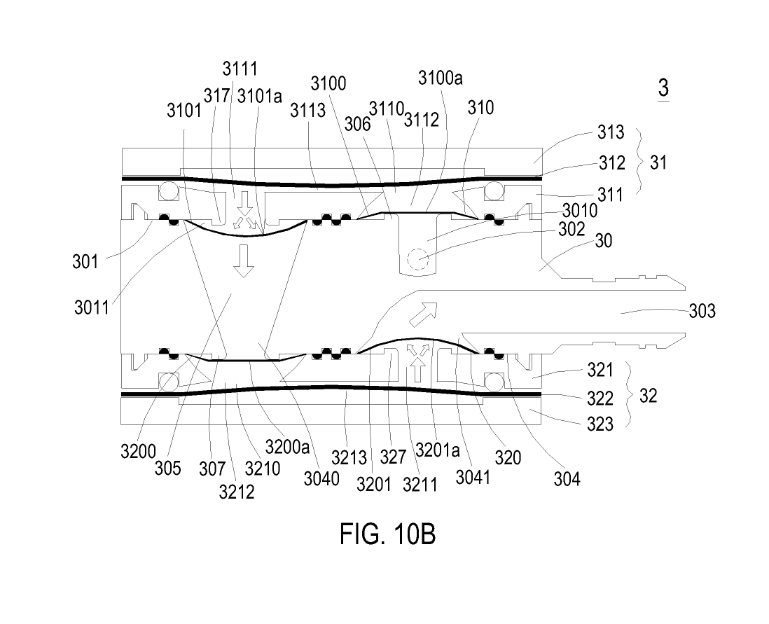

FIG. 10A schematically illustrates the in-phase actuations of the first fluid transportation module and the second fluid transportation module of the fluid transportation device of FIG. 9D in a first situation. When a voltage is applied to the actuating member 312 of the first fluid transportation module 31 and the actuating member 322 of the second fluid transportation module 32 to cause in-phase actuations of the actuating member 312 and the actuating member 322 at the same vibration frequency, the actuating member 312 and the actuating member 322 are synchronously subjected to deformation. Since the first fluid transportation module 31 is disposed on first surface 301 of the valve supporting module 30 and the second fluid transportation module 32 is disposed on the second surface 304 of the valve supporting module 30, the actuating member 312 of the first fluid transportation module 31 is subjected to upward deformation and the actuating member 322 of the second fluid transportation module 32 is subjected to downward deformation. Consequently, the volume of the first pressure cavity 3113 is expanded to result in suction. Due to the suction, the hollow-type valve switch 3100 of the valve membrane 310 is moved upwardly. In response to the pre-force provided by the raised structure 306 of the valve supporting module 30, the hollow-type valve switch 3100 is quickly opened. Consequently, a great amount of fluid is sucked into the inlet channel 302 of the valve supporting module 30. The fluid is sequentially transported through the hollow-type valve switch 3100, the inlet buffer cavity 3112 of the valve cap 311 and the inlet valve channel 3110 of the valve cap 311, and introduced into the first pressure cavity 3113. Similarly, an upward pulling force is exerted on the hollow-type valve switch 3101 at another side of the valve membrane 310. Moreover, since the raised structure 317 at the periphery of the outlet valve channel 3111 provides a pre-sealing effect, the hollow-type valve switch 3101 is closed to prevent backflow. Moreover, since the actuating member 322 of the second fluid transportation module 32 is subjected to downward deformation, the volume of the second pressure cavity 3213 is expanded to result in suction. Due to the suction, the hollow-type valve switch 3200 of the valve membrane 320 is moved downwardly. In response to the pre-force provided by the raised structure 307 of the valve supporting module 30, the hollow-type valve switch 3200 is quickly opened. Consequently, a great amount of fluid is sucked from the communication chamber 305. The fluid is sequentially transported through the hollow-type valve switch 3200, the inlet buffer cavity 3212 of the valve cap 321 and the inlet valve channel 3210 of the valve cap 321, and introduced into the second pressure cavity 3213. Similarly, an upward pulling force is exerted on the hollow-type valve switch 3201 of the valve membrane 320. Moreover, since the raised structure 327 at the periphery of the outlet valve channel 3211 provides a pre-sealing effect, the hollow-type valve switch 3201 is closed to prevent backflow.

In other words, when a voltage is applied to both of the actuating member 312 of the first fluid transportation module 31 and the actuating member 322 of the second fluid transportation module 32, the first pressure cavity 3113 and the second pressure cavity 3213 are synchronously expanded. Consequently, the fluid is driven to be introduced into the first pressure cavity 3113 and the second pressure cavity 3213.

FIG. 10B schematically illustrates the in-phase actuations of the first fluid transportation module and the second fluid transportation module of the fluid transportation device of FIG. 9D in a second situation. When a voltage opposite to the voltage of FIG. 10A is applied to both of the actuating member 312 of the first fluid transportation module 31 and the actuating member 322 of the second fluid transportation module 32, the actuating member 312 of the first fluid transportation module 31 is subjected to downward deformation. Consequently, the volume of the first pressure cavity 3113 is shrunken to exert an impulse on the fluid within the first pressure cavity 3113. Due to the impulse, the hollow-type valve switch 3101 corresponding to the raised structure 317 is quickly opened, and thus a great amount of fluid is instantaneously ejected out of the first pressure cavity 3113. The fluid is flowed into the communication chamber 305 of the valve supporting module 30 through the hollow-type valve switch 3101. Similarly, a downward pressing force is exerted on the hollow-type valve switch 3100 of the valve membrane 310. Moreover, since the raised structure 306 of the valve supporting module 30 provides a pre-sealing effect, the hollow-type valve switch 3100 is closed. At the same time, the actuating member 322 of the second fluid transportation module 32 is synchronously subjected to upward deformation. Consequently, the volume of the second pressure cavity 3213 is shrunken to exert an impulse on the fluid within the second pressure cavity 3213. Due to the impulse, the hollow-type valve switch 3201 corresponding to the raised structure 327 is quickly opened, and thus a great amount of fluid is instantaneously ejected out of the second pressure cavity 3213. The fluid is flowed into the outlet buffer cavity 3041 of the valve supporting module 30 through the hollow-type valve switch 3201, and then flowed out of the fluid transportation device 3 through the outlet channel 303. Moreover, since the raised structure 307 of the valve supporting module 30 provides a pre-sealing effect, the hollow-type valve switch 3200 of the valve membrane 320 of the second fluid transportation module 32 is closed to prevent backflow.

From the above discussions, when the same voltage is applied to the fluid transportation device 3 to cause actuations of the actuating member 312 of the first fluid transportation module 31 and the actuating member 322 of the second fluid transportation module 32 at the same vibration frequency, the fluid transportation device 3 can sequentially inhale and exhaust the liquid in order to increase the flow rate and the pumping head of the fluid.

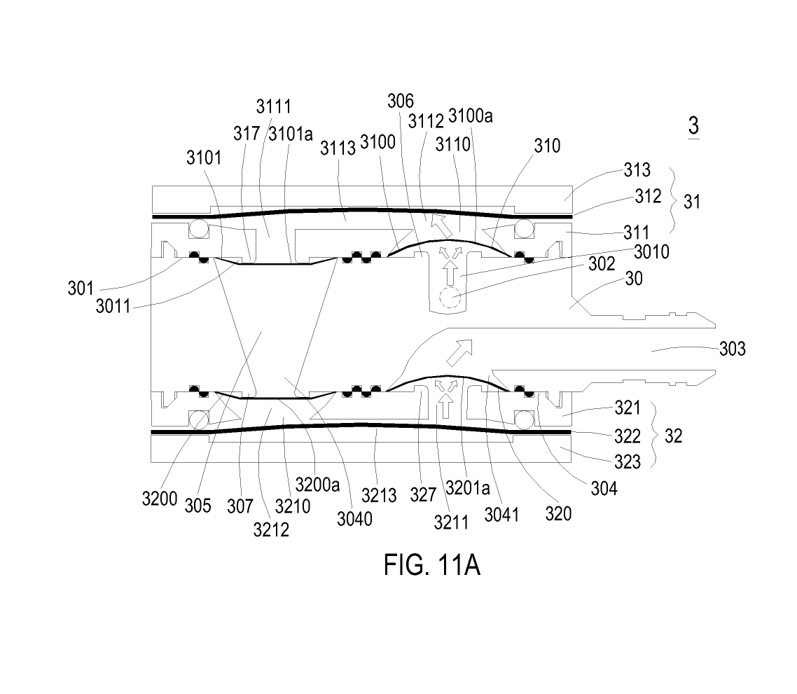

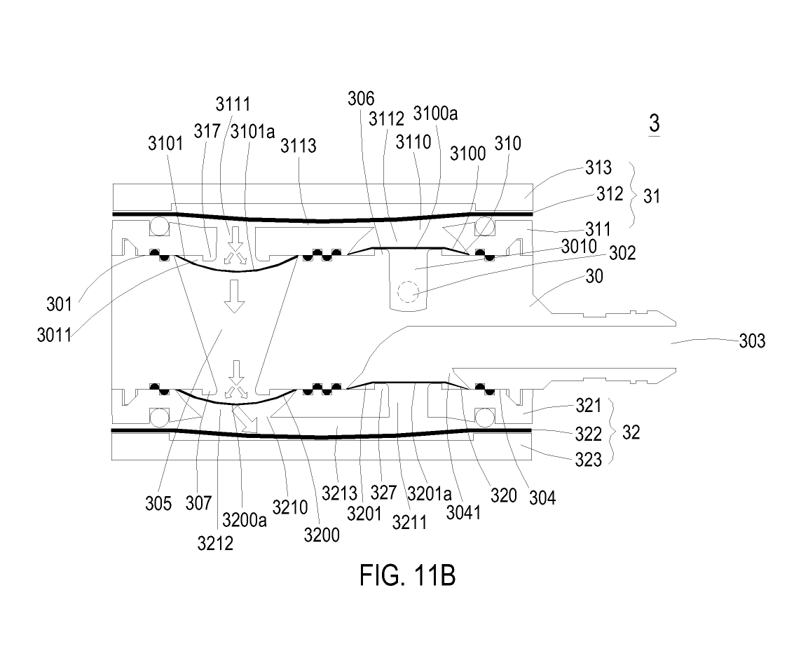

FIG. 11A schematically illustrates the out-phase actuations of the first fluid transportation module and the second fluid transportation module of the fluid transportation device of FIG. 9D in a first situation. When a voltage is applied to the actuating member 312 of the first fluid transportation module 31 and the actuating member 322 of the second fluid transportation module 32 to cause out-phase actuations of the actuating member 312 and the actuating member 322 at the same vibration frequency, the actuating member 312 of the first fluid transportation module 31 is subjected to upward deformation. Consequently, the volume of the first pressure cavity 3113 is expanded to result in suction. Due to the suction, the hollow-type valve switch 3100 of the valve membrane 310 is opened. Consequently, the fluid is sucked into the inlet channel 302 of the valve supporting module 30. Moreover, an upward pulling force is exerted on the hollow-type valve switch 3101 of the valve membrane 310, so that the hollow-type valve switch 3101 is closed. On the other hand, the actuating member 322 of the second fluid transportation module 32 is also subjected to upward deformation. Consequently, the volume of the second pressure cavity 3213 is shrunken to exert an impulse. Due to the impulse, the hollow-type valve switch 3201 is opened. Consequently, the fluid is transported from the second pressure cavity 3213 to the outlet channel 303 of the valve supporting module 30, and flowed out of the fluid transportation device 3. Moreover, since the raised structure 307 of the valve supporting module 30 provides a pre-sealing effect, the hollow-type valve switch 3200 is closed to prevent the fluid from flowing back to the communication chamber 305 of the valve supporting module 30.

From the above discussions, when the same voltage is applied to the actuating member 312 of the first fluid transportation module 31 and the actuating member 322 of the second fluid transportation module 32 to cause out-phase actuations of the actuating member 312 and the actuating member 322 at the same vibration frequency, the volume of the first pressure cavity 3113 of the first fluid transportation module 31 is expanded, but the volume of the second pressure cavity 3213 of the second fluid transportation module 32 is shrunken. Consequently, the fluid is driven to be introduced into the first fluid transportation module 31 through the inlet channel 302, and the fluid in the second pressure cavity 3213 of the second fluid transportation module 32 is driven to be transported to the outlet channel 303. In other words, the fluid can be simultaneously flowed into and flowed out of the fluid transportation device 3.

FIG. 11B schematically illustrates the out-phase actuations of the first fluid transportation module and the second fluid transportation module of the fluid transportation device of FIG. 9D in a second situation. When a voltage opposite to the voltage of FIG. 11A is applied to both of the actuating member 312 of the first fluid transportation module 31 and the actuating member 322 of the second fluid transportation module 32, the actuating member 312 of the first fluid transportation module 31 is subjected to downward deformation. Consequently, the volume of the first pressure cavity 3113 is shrunken to exert an impulse. Due to the impulse, the hollow-type valve switch 3101 is correspondingly opened, and thus a great amount of fluid is instantaneously ejected out of the first pressure cavity 3113. The fluid is flowed into the communication chamber 305 of the valve supporting module 30 through the hollow-type valve switch 3101. Moreover, a downward pressing force is exerted on the hollow-type valve switch 3100 at another side of the valve membrane 310. Since the raised structure 306 of the valve supporting module 30 provides a pre-sealing effect, the hollow-type valve switch 3100 is closed to prevent the fluid from flowing back to the first fluid transportation module 31. At the same time, the actuating member 322 of the second fluid transportation module 32 is synchronously subjected to downward deformation. Consequently, the volume of the second pressure cavity 3213 is expanded to result in suction. Due to the suction, the hollow-type valve switch 3200 of the valve membrane 320 is opened downwardly. Consequently, a great amount of fluid is flowed from the communication chamber 305 of the valve supporting module 30 to the second pressure cavity 3213 of the second fluid transportation module 32. Moreover, since a downward pulling force is exerted on the hollow-type valve switch 3201 of the valve membrane 320 and raised structure 327 at the periphery of the outlet valve channel 3211 provides a pre-sealing effect, the hollow-type valve switch 3201 is closed. Under this circumstance, the fluid fails to be flowed into the outlet channel 303.

In the embodiments of FIGS. 10A, 10B, 11A and 11B, the in-phase actuations or the out-phase actuations of the actuating member 312 of the first fluid transportation module 31 and the actuating member 322 of the second fluid transportation module 32 synchronously performed at the same vibration frequency. In some other embodiments, the actuating member 312 of the first fluid transportation module 31 and the actuating member 322 of the second fluid transportation module 32 are asynchronously actuated. That is, the vibration frequency is the same, but there is a phase difference θ between the deformation amount of the actuating member 312 and the actuating member 322. By asynchronously changing the electric field, the actuating member 312 of the first fluid transportation module 31 and the actuating member 322 of the second fluid transportation module 32 are sequentially enabled according to a delaying time. Consequently, the actuating member 312 and the actuating member 322 are asynchronously actuated to achieve the purpose of transporting the fluid.

Please refer to FIGS. 7B, 8, 10A, 10B, 11A and 11B again. The actuating member 312 of the first fluid transportation module 31 and the actuating member 322 of the second fluid transportation module 32 are vibrated at the same vibration frequency, but the first pressure cavity 3113 and the second pressure cavity 3213 are asynchronously shrunken or expanded. That is, there is a phase difference θ between the deformation amount of the actuating member 312 of the first fluid transportation module 31 and the deformation amount of the actuating member 322 of the second fluid transportation module 32. Consequently, there is the phase difference θ between the volume change of the first pressure cavity 3213 and the voltage change of the second pressure cavity 3213 (see FIG. 7B). By adjusting the magnitude of the phase difference θ, the flow rate and the pumping head of the fluid transportation device are correspondingly adjusted. Moreover, as shown in FIG. 8, the out-phase actuations of the actuating member 312 of the first fluid transportation module 31 and the actuating member 322 of the second fluid transportation module 32 can be used to controlled the operating performance, the flow rate or the pumping head of the fluid transportation device 3. Since the optimal flow rate and the optimal pumping head can be determined according to the practical requirements, the fluid transportation device of the present invention can be applied to various products more flexibly.

During operation of the single actuating member of the conventional fluid transportation device is driven at a 45 Hz vibration frequency, the flow rate is about 50 ml/min, and the pumping head is about 45 kPa. When the fluid transportation device 3 with the two vertically-stacked fluid transportation modules 31 and 32 is used, in response to the in-phase actuations of the actuating members of these two fluid transportation modules 31 and 32 at the same vibration frequency (e.g. 45 Hz), the use of the fluid transportation device 3 can increase the flow rate to about 80 ml/min and increase the pumping head to about 65 kPa. On the other hand, in response to the out-phase of the actuating members of these two fluid transportation modules 31 and 32 at the same vibration frequency (e.g. 45 Hz), the use of the fluid transportation device 3 can even increase the pumping head to about 100 kPa. In comparison with the conventional fluid transportation device having the single actuating member, the use of the fluid transportation device 3 can largely increase the flow rate and the pumping head.

From the above descriptions, the present invention provides a fluid transportation device. The fluid transportation device may be applied to a micro pump. The fluid transportation device comprises a valve supporting module, a first fluid transportation module and a second fluid transportation module. Through the valve supporting module, the first fluid transportation module and the second fluid transportation module may be combined together in a side-by-side arrangement or a vertically-stacked arrangement. In comparison with the conventional fluid transportation device with a single fluid transportation module, the combination of the first fluid transportation module and the second fluid transportation module can increase the flow rate and the pumping head of transporting the fluid. Moreover, in comparison with the conventional way of using a coupling mechanism (e.g. a piping system) to connect plural fluid transportation devices to increase the flow rate, the combination of two fluid transportation modules of the present fluid transportation device can be synchronously or asynchronously actuated to increase the flow rate and the pumping head of transporting the fluid. Since the additional coupling mechanism is omitted, the fabricating cost of the present fluid transportation device is largely reduced, and the overall volume of the present fluid transportation device is reduced to comply with the miniaturization requirement.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A fluid transportation device for transporting a fluid, said fluid transportation device comprising:
a valve supporting module comprising a first valve seat, a second valve seat, an inlet channel, an outlet channel and a communication chamber, wherein said first valve seat and said second valve seat are located adjacent to each other and arranged at the same plane, wherein said first valve seat comprises an outlet buffer cavity and an opening, and said opening of said first valve seat is in communication with said inlet channel, wherein said second valve seat comprises an opening and an outer buffer cavity, and said outer buffer cavity of said second valve seat is in communication with said outlet channel, wherein said outlet buffer cavity of said first valve seat and said opening of said second valve seat are in communication with each other through said communication chamber;
a first fluid transportation module disposed on said first valve seat of said valve supporting module, and comprising an actuating member, a valve cap and a valve membrane, wherein said valve membrane is arranged between said valve supporting module and said valve cap, and has plural hollow-type valve switches respectively corresponding to said opening and said outlet buffer cavity of said first valve seat, wherein said actuating member is disposed on said valve cap, and a first pressure cavity is defined between said actuating member and a surface of said valve cap; and
a second fluid transportation module disposed on said second valve seat of said valve supporting module, and comprising an actuating member, a valve cap and a valve membrane, wherein said valve membrane is arranged between said valve supporting module and said valve cap, and has plural hollow-type valve switches respectively corresponding to said opening and said outlet buffer cavity of said second valve seat, wherein said actuating member is disposed on said valve cap, and a second pressure cavity is defined between said actuating member and a surface of said valve cap,
wherein when said actuating member of said first fluid transportation module and said actuating member of said second fluid transportation module are actuated at the same vibration frequency and with a phase difference to cause a volume change of said first pressure cavity and a volume change of said second pressure cavity, a pressure difference is generated to push said fluid, so that said fluid is introduced into said inlet channel of said valve supporting module, transported between said first fluid transportation module, said first valve seat, said second valve seat and said second fluid transportation module, and exhausted out of said outlet channel of said valve supporting module.

2. The fluid transportation device according to claim 1, wherein each of said valve membrane of said first fluid transportation module and said valve membrane of said second fluid transportation module is a sheet-like membrane with substantially uniform thickness, wherein each of said hollow-type valve switches comprises a valve slice, plural perforations around said valve slice, and plural extension parts between said valve slice and said perforations.

3. The fluid transportation device according to claim 1, wherein said valve cap of said first fluid transportation module comprises an inlet valve channel and an outlet valve channel, which are respectively aligned with said hollow-type valve switches of said valve membrane, wherein an inlet buffer cavity is arranged between said valve cap and said valve membrane and aligned with said opening of said first valve seat, said inlet buffer cavity is in communication with said first pressure cavity through said inlet valve channel, and said inlet buffer cavity is in communication with said outlet valve channel through said first pressure cavity, wherein said outlet valve channel is communication with said outlet buffer cavity of said first valve seat, so that said first valve seat is in communication with said second valve seat through said communication chamber.

4. The fluid transportation device according to claim 3, wherein a raised structure is formed at a periphery of said outlet valve channel of said valve cap of said first fluid transportation module, and said raised structure is sustained against said valve slice of said corresponding hollow-type valve switch of said valve membrane to provide a pre-force.

5. The fluid transportation device according to claim 1, wherein said valve cap of said second fluid transportation module comprises an inlet valve channel and an outlet valve channel, which are respectively aligned with said hollow-type valve switches of said valve membrane, wherein an inlet buffer cavity is arranged between said valve cap and said valve membrane and aligned with said opening of said second valve seat, said inlet buffer cavity is in communication with said second pressure cavity through said inlet valve channel, and said inlet buffer cavity is in communication with said outlet valve channel through said second pressure cavity, wherein said outlet valve channel is communication with said outlet buffer cavity of said second valve seat and said outlet channel of said valve supporting module.

6. The fluid transportation device according to claim 5, wherein a raised structure is formed at a periphery of said outlet valve channel of said valve cap of said second fluid transportation module, and said raised structure is sustained against said valve slice of said corresponding hollow-type valve switch of said valve membrane to provide a pre-force.

7. The fluid transportation device according to claim 1, wherein two raised structures are respectively formed at peripheries of said openings of said first valve seats and said second valve seats of said valve supporting module, wherein said two raised structures are respectively sustained against said valve slices of said corresponding hollow-type valve switches of said valve membranes of said first and said second fluid transportation modules to provide pre-forces.

8. The fluid transportation device according to claim 1, wherein said actuating member of said first fluid transportation module and said actuating member of said second fluid transportation module are synchronously or asynchronously actuated to adjusting a flow rate and a pumping head of transporting said fluid.

9. A fluid transportation device for transporting a fluid, said fluid transportation device comprising:
a valve supporting module comprising a first surface, an inlet channel, an outlet channel, a second surface and a communication chamber, wherein an outlet buffer cavity and an opening are formed in said first surface, and said opening of said first surface is in communication with said inlet channel, wherein an opening and an outer buffer cavity are formed in said second surface, and said outer buffer cavity of said second surface is in communication with said outlet channel, wherein said outlet buffer cavity of said first surface and said opening of said second surface are in communication with each other through said communication chamber;
a first fluid transportation module disposed on said first surface of said valve supporting module, and comprising an actuating member, a valve cap and a valve membrane, wherein said valve membrane is arranged between said valve supporting module and said valve cap, and has plural hollow-type valve switches respectively corresponding to said opening and said outlet buffer cavity of said first surface, wherein said actuating member is disposed on said valve cap, and a first pressure cavity is defined between said actuating member and a surface of said valve cap; and
a second fluid transportation module disposed on said second surface of said valve supporting module, and located over or under said first fluid transportation module, wherein said second fluid transportation module comprises an actuating member, a valve cap and a valve membrane, wherein said valve membrane is arranged between said valve supporting module and said valve cap, and has plural hollow-type valve switches respectively corresponding to said opening and said outlet buffer cavity of said second surface, wherein said actuating member is disposed on said valve cap, and a second pressure cavity is defined between said actuating member and a surface of said valve cap,
wherein when said actuating member of said first fluid transportation module and said actuating member of said second fluid transportation module are actuated at the same vibration frequency and with a phase difference to cause a volume change of said first pressure cavity and a volume change of said second pressure cavity, a pressure difference is generated to push said fluid, so that said fluid is introduced into said inlet channel of said valve supporting module, transported between said first fluid transportation module, said first valve seat, said second valve seat and said second fluid transportation module, and exhausted out of said outlet channel of said valve supporting module.

10. The fluid transportation device according to claim 9, wherein said communication chamber is tapered from said outlet buffer cavity of said first surface to said opening of said second surface.

11. The fluid transportation device according to claim 9, wherein each of said valve membrane of said first fluid transportation module and said valve membrane of said second fluid transportation module is a sheet-like membrane with substantially uniform thickness, wherein each of said hollow-type valve switches comprises a valve slice, plural perforations around said valve slice, and plural extension parts between said valve slice and said perforations.

12. The fluid transportation device according to claim 9, wherein said valve cap of said first fluid transportation module comprises an inlet valve channel and an outlet valve channel, which are respectively aligned with said hollow-type valve switches of said valve membrane, wherein an inlet buffer cavity is arranged between said valve cap and said valve membrane and aligned with said opening of said first surface, said inlet buffer cavity is in communication with said first pressure cavity, and said inlet buffer cavity is in communication with said outlet valve channel through said first pressure cavity, wherein said outlet valve channel is communication with said outlet buffer cavity of said first surface.

13. The fluid transportation device according to claim 12, wherein a raised structure is formed at a periphery of said outlet valve channel of said valve cap of said first fluid transportation module, and said raised structure is sustained against said valve slice of said corresponding hollow-type valve switch of said valve membrane to provide a pre-force.

14. The fluid transportation device according to claim 9, wherein said valve cap of said second fluid transportation module comprises an inlet valve channel and an outlet valve channel, which are respectively aligned with said hollow-type valve switches of said valve membrane, wherein an inlet buffer cavity is arranged between said valve cap and said valve membrane and aligned with said opening of said second surface of said valve supporting module, said inlet buffer cavity is in communication with said second pressure cavity, and said inlet buffer cavity is in communication with said outlet valve channel through said second pressure cavity, wherein said outlet valve channel is communication with said outlet buffer cavity of said second surface and said outlet channel.

15. The fluid transportation device according to claim 14, wherein a raised structure is formed at a periphery of said outlet valve channel of said valve cap of said second fluid transportation module, and said raised structure is sustained against said valve slice of said corresponding hollow-type valve switch of said valve membrane to provide a pre-force.

16. The fluid transportation device according to claim 9, wherein two raised structures are respectively formed at peripheries of said openings of said first and said second surfaces of said valve supporting module, wherein said two raised structures are respectively sustained against said valve slices of said corresponding hollow-type valve switches of said valve membranes of said first and said second fluid transportation modules to provide pre-forces.

17. The fluid transportation device according to claim 9, wherein said actuating member of said first fluid transportation module and said actuating member of said second fluid transportation module are synchronously or asynchronously actuated to adjusting a flow rate and a pumping head of transporting said fluid.
